(19) United States
(12) Patent Application Publication
(10) Pub. No.: US 2026/0250556 A1
(43) Pub. Date: Aug. 27, 2026

(54) RELEASE FILM, METHOD FOR MANUFACTURING SAME, AND FILM LAMINATE

(71) Applicant: TORAY ADVANCED FILM CO., LTD., Tokyo (JP)

(72) Inventors: Yasuhiro KASAHARA, Iwase-gun (JP); Takenori UEOKA, Iwase-gun (JP)

(73) Assignee: TORAY ADVANCED FILM CO., LTD., Tokyo (JP)

(21) Appl. No.: 19/163,254

(22) PCT Filed: Feb. 29, 2024
(86) PCT No.: PCT/JP2024/007486

§ 371 Date: Sep. 8, 2025

(30) Foreign Application Priority Data
Mar. 9, 2023 (JP) 2023-036315

(51) Int. Cl. C09J 7/20; G02F 1/1335

(52) U.S. Cl. CPC C09J 7/201; C09J 2203/37; C09J 2301/312; G02F 1/133528

(57) ABSTRACT

The purpose of the present invention is to provide a release film that can be stably used in manufacturing processes, exhibits low peel strength, and does not undergo release-layer deformation. A release film having a release layer on at least one surface of a base-material film, the elastic modulus (E) of the release film as measured from the release-layer-surface side using an atomic force microscope being at least 1.5 MPa but less than 5.0 MPa, the thickness of the release layer being at least 0.03 μm but less than 0.3 μm, and deformation in the release layer being equal to or less than 0.1 μm as a difference in height.

### TECHNICAL FIELD

The present invention relates to a release film, a method for manufacturing the same, and a film laminate.

### BACKGROUND ART

In order to protect a surface to be in contact with an adherend of an adhesive sheet, a release film having a base-material film, and a release layer provided on the surface of the base-material film is used. Patent Documents 1 to 3 disclose examples of the release film. Patent Document 1 discloses a release film having a crosslinked resin layer formed of a crosslinked thermoplastic resin, wherein, when the thermoplastic resin that has not been crosslinked has a melting point of Tm (° C.), the percentage of the storage elastic modulus of the release film at Tm+20 (° C.) with respect to the storage elastic modulus of the release film at Tm (° C.) is 50% or more.

Patent Document 2 discloses a release sheet having a base material, and a release agent layer provided on at least one surface side of the base material, wherein the base material is made of a plastic film; the release agent layer is formed from a release agent composition containing a polyorganosiloxane having a weight average molecular weight of 5000 or more and 100000 or less; the release agent layer has a thickness of 0.3 μm or more and 1.0 μm or less; and the release sheet has an elastic modulus of 1.5 MPa or more and 5.0 MPa or less, the elastic modulus being measured from the opposite surface side of the release agent layer against the base material by using an atomic force microscope.

Patent Document 3 discloses a release film having a base-material film, and a release layer provided on one surface side of the base-material film, wherein the release layer has a cohesive energy of 35 mJ/m² or more and 39 mJ/m² or less; and the release film has a 180° peel strength of 15 mN/cm or less under the condition of a tensile speed of 300 mm/min, after an acrylic adhesive tape is bonded on the release layer and cut into a size of 50 mm×300 mm, and the resultant is heated and held in a hot air oven at 100° C. (set temperature) for 1 hour, and then left standing at 23° C. and 50% RH for 1 hour.

However, in recent years, liquid crystal televisions, smartphones, tablets, and the like have been thinned more and more, and there is a need to thin various electronic members constituting these liquid crystal televisions, smartphones, and tablets. The polarizing plate, one of the electronic members, also has been thinned rapidly. The production of a liquid crystal television or the like using a polarizing plate includes a step of bonding a protective film, a polarizing plate, an adhesive, and a release film, the release surface of the release film being bonded on the adhesive surface of the adhesive, and then peeling the release layer of the release film from the adhesive surface. Hitherto, when the polarizing plate is thick, the adhesive surface and the release layer have been favorably peeled off. However, when the polarizing plate becomes thinner, the polarizing plate loses stiffness, which arises a problem that when the release film is peeled from the adhesive surface, the protective film and the polarizing plate are also peeled therefrom.

### PRIOR ART DOCUMENTS

### Patent Documents

Patent Document 1: Japanese Patent Laid-open Publication No. 2013-189493
Patent Document 2: Japanese Patent Laid-open Publication No. 2017-149048
Patent Document 3: Japanese Patent Laid-open Publication No. 2022-36894

### SUMMARY OF THE INVENTION

### Problems to be Solved by the Invention

In the conventional release films as disclosed in Patent Documents 1 to 3, when the elastic modulus is high, the peel strength is not sufficiently small; and when the elastic modulus is small, the peel strength is small, but the release layer is deformed due to external pressure. Therefore, the conventional release films cannot be stably used in the above step to handle the above situation.

In order to solve the above-described problems, an object of the present invention is to provide a release film that has a small peel strength and small deformation of the release layer, and can be stably used in a manufacturing process.

### Solutions to the Problems

In order to solve the problems described above, the present invention includes the following configurations. That is:
(1) A release film including: a base-material film; and a release layer on at least one surface of the base-material film, wherein the release film has an elastic modulus (E) of 1.5 MPa or more and less than 5.0 MPa, the elastic modulus (E) being measured from a release layer surface side using an atomic force microscope; the release layer has a thickness of 0.03 μm or more and less than 0.3 μm; and the release layer has a maximum height difference of 0.1 μm or less after pressurized at 10 MPa.
(2) The release film according to (1), wherein, when the release layer is bonded with an adhesive tape and left standing at 23° C. for 24 hours, and then the tape is peeled off at a peeling rate of 300 mm/min and a peeling angle of 180°, the release film and the adhesive tape have a peel strength of 5 mN/50 mm or more and 100 mN/50 mm or less.
(3) A film laminate including: the release film according to (1); and an optical member bonded to the release film through an adhesive layer.
(4) A method for manufacturing a release film having: a base-material film; and a release layer on at least one surface of the base-material film, the method including: a step of applying a release agent to a base-material film; and a step of curing the applied release agent, wherein at least one of the release agents has at least one absorption selected from the group consisting of νC—H, νSi-H, δSi—CH₃, νSi—C, and νSi—O—Si in an IR measurement spectrum; thermal decomposition products of following formulae (1) to (5) are detected by thermal decomposition gas chromatograph mass spectrometry; and substituents Si—CH₃, Si—CH₂CH₂CH₂CH₂CH═CH₂, and Si—H have molar ratios of 90.0 or more and 99.0 or less, 0.3 or more and 3.0 or less, and 0.3 or more and 3.0 or less, respectively, the molar ratios being calculated from 1H NMR spectrum.

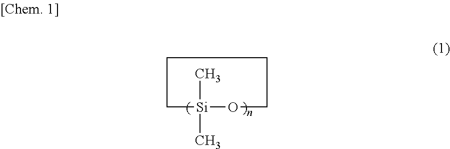

(n represents an integer of 1 to 20)

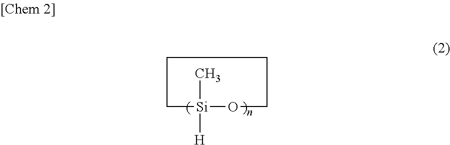

(n represents an integer of 1 to 20)

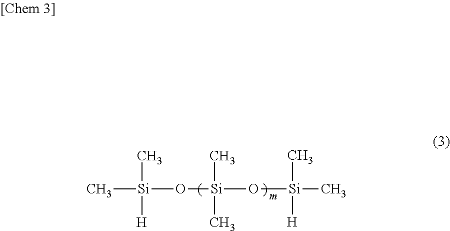

(m represents an integer of 1 to 10)

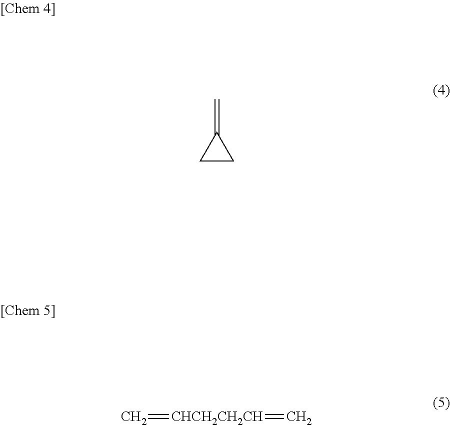

### Effects of the Invention

The release film of the present invention has a small peel strength and small deformation of the release layer, and can be stably used in a manufacturing process.

### BRIEF DESCRIPTION OF THE DRAWINGS

FIG. 1 is a schematic cross-sectional view of an example of the release film of the present invention.

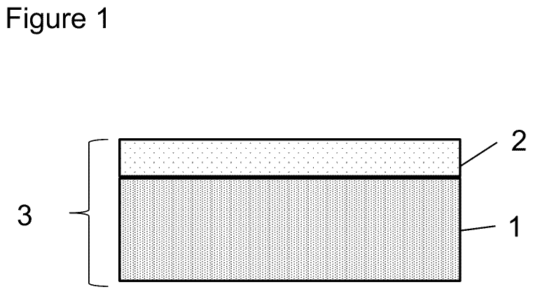

FIG. 2 is a view of an example to be noted when the height difference is measured for the deformation of the release layer of the release film of the present invention.

### EMBODIMENTS OF THE INVENTION

The present invention is a release film including: a base-material film; and a release layer on at least one surface of the base-material film, wherein the release film has an elastic modulus (E) of 1.5 MPa or more and less than 5.0 MPa, the elastic modulus (E) being measured from the release layer surface side using an atomic force microscope; the release layer has a thickness of 0.03 μm or more and less than 0.3 μm; and the release layer is deformed in a height difference of 0.1 μm or less.

In the present invention, the base-material film is preferably made of a plastic film. Examples of the plastic film include: polyesters such as polyethylene terephthalate and polyethylene naphthalate; polyolefins such as polypropylene and polymethylpentene; polycarbonate; and polyvinyl acetate. These plastic films may have a single layer or a multilayer of two or more layers of the same kind or different kinds. Among them, a polyester film is preferable, and a polyethylene terephthalate film is particularly preferable. Since the polyethylene terephthalate film hardly generates dust or the like during processing, use, or the like, for example, coating failure or the like due to dust or the like can be effectively prevented.

If desired, the surface on which the release layer is laminated or both surfaces of the base-material film may be subjected to a surface treatment by an oxidation method, a roughening method, or the like, or a primer treatment. By performing such a treatment, adhesion between the base-material film and the release layer is easily improved. Examples of the oxidation method include a corona discharge treatment, a plasma discharge treatment, a chromium oxidation treatment (wet type), a flame treatment, a hot air treatment, an ozone treatment, and an ultraviolet irradiation treatment. Examples of the roughening method include a sand blasting method and a thermal spraying treatment method. These surface treatment methods are appropriately selected according to the type of the base-material film. From the viewpoint of effects and operability, a corona discharge treatment method is preferable.

The thickness of the base-material film is preferably 10 μm or more, particularly preferably 15 μm or more, and more preferably 20 μm or more. The thickness is preferably 300 μm or less, particularly preferably 200 μm or less, and more preferably 125 μm or less. When the thickness of the base-material film is 10 μm or more, wrinkles are less likely to be formed when heat is applied during conveyance or in a subsequent step, so that workability is easily improved. When the thickness of the base-material film is 300 μm or less, the stiffness of the film does not become too strong, and workability is easily improved.

The release film of the present invention has an elastic modulus (E) of 1.5 MPa or more and less than 5.0 MPa, the elastic modulus (E) being measured from the release layer surface side using an atomic force microscope. The elastic modulus (E) of the release film is preferably 1.5 MPa or more and 4.2 MPa or less. When the elastic modulus (E) of the release film is less than 1.5 MPa, the release layer is deformed by external pressure, the deformation is transferred to the adhesive layer and appearance defects occur. When the elastic modulus (E) is 5.0 MPa or more, the peel strength increases and workability deteriorates. In the present invention, the elastic modulus of the release film is measured by the method described later. In the present invention, examples of the method for setting the elastic modulus of the release film within the above range include: a method of adjusting the crosslinking density of a resin for forming the release layer; a method of containing a low molecular resin in a release layer coating liquid; and a method of adjusting the thickness of the release layer.

The release film of the present invention has a release layer on at least one surface of the base-material film. Examples of the material for forming the release layer include an alkyd resin release agent, a polyolefin release agent, a long-chain alkyl group-containing resin release agent, a fluorine release agent, a silicone release agent, and a copolymerized resin release agent containing an acryl-silicone graft copolymer or the like. Among them, the silicone release agent is preferable because it exhibits excellent releasability and heat resistance. Examples of the silicone release agent, classified by the reaction form, include a thermosetting type such as an addition reaction type and a condensation reaction type, an ultraviolet curing type, an electron beam curing type, and a combined curing type of heat and ultraviolet rays. Any of the silicone release agents may be used.

The release film of the present invention may have a primer layer between the release layer and the base-material film. By selecting the type of the primer layer, it is possible to prevent the release layer from falling off from the base-material film, to improve adhesion between the release layer and the base-material film, and to prevent precipitates such as oligomers from the base-material film from being precipitated on the surface of the release layer.

Examples of the primer layer include coating agents containing, as a main component, a polyester resin, a urethane resin, an acrylic resin, an oxazoline group-containing resin, a carbodiimide group-containing resin, an epoxy group-containing resin, an isocyanate-containing resin, a copolymer thereof, a natural rubber, and a synthetic rubber. One of these resins may be contained alone, or two different resins may be contained in combination. When the release layer is formed on the base-material film, the primer layer may be applied one or two or more times.

In the release film of the present invention, the thickness of the release layer is preferably 0.03 μm or more and less than 0.3 μm. The thickness of the release layer is more preferably 0.05 μm or more and 0.2 μm or less. When the thickness of the release layer is 0.03 μm or more, the peel strength tends to be light and workability is improved. When the thickness is less than 0.3 μm, the release layer is less likely to crack during peeling.

In the release film of the present invention, the height difference of the deformation of the release layer is preferably 0.1 μm or less. The height difference of the deformation of the release layer can be measured by the method described later. The height difference of the deformation of the release layer is more preferably 0.08 μm or less. When the height difference of the deformation of the release layer exceeds 0.1 μm, the deformation of the release layer is transferred to the adhesive, and when the adhesive is bonded to an optical member, defects such as appearance defects occur. Examples of the method for suppressing the deformation of the release layer include: a method of adjusting the crosslinking density by the amount of Si—O—Si and Si—CH₂CH₂CH₂CH₂CH═CH₂ in the resin forming the release layer; a method of containing a low molecular resin in a release layer coating liquid; and a method of adjusting the thickness of the release layer.

In the present invention, when the release layer is bonded with an adhesive tape and left standing at 23° C. for 24 hours, and then the tape is peeled off at a peeling rate of 300 mm/min and a peeling angle of 180°, the release film and the adhesive tape preferably have a peel strength of 5 mN/50 mm or more and 100 mN/50 mm or less. The peel strength is more preferably 5 mN/50 mm or more and 60 mN/50 mm or less. When the peel strength is less than 5 mN/50 mm, the release film may be easily peeled off during conveyance. When the peel strength exceeds 100 mN/50 mm, workability tends to deteriorate. In the present invention, the peel strength is measured by the method described later.

The present invention is a method for manufacturing a release film having: a base-material film; and a release layer on at least one surface of the base-material film, the method including: a step of applying a release agent to a base-material film; and a step of curing the applied release agent, wherein at least one of the release agents has at least absorption of νC—H, νSi-H, δSi—CH₃, νSi—C, and νSi—O—Si in an IR measurement spectrum; the following formula (1) is detected and thermal decomposition products of the following formulae (2), (3), (4), and (5) are detected by thermal decomposition gas chromatograph mass spectrometry; and substituents Si—CH₃, Si—CH₂CH₂CH₂CH₂CH═CH₂, and Si—H have molar ratios of 90 or more and 99 or less, 0.3 or more and 3.0 or less, and 0.3 or more and 3.0 or less, respectively, the molar ratios being calculated from ¹H NMR spectrum.

In the present invention, examples of the method for adjusting the measurement results of IR measurement, thermal decomposition gas chromatograph mass spectrometry (hereinafter, sometimes referred to as thermal decomposition GC/MS measurement), and ¹H NMR spectrum within the above include: adjusting the main skeleton of the resin forming the release layer; and adjusting the content of the low molecular resin.

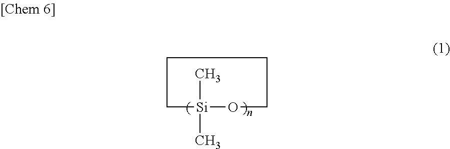

(n represents an integer of 1 to 20)

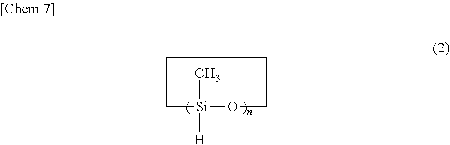

(n represents an integer of 1 to 20)

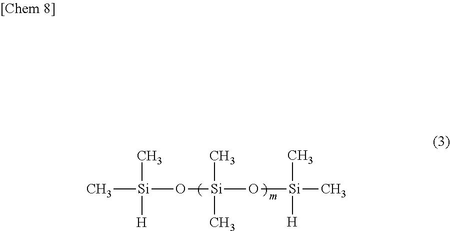

(m represents an integer of 1 to 10)

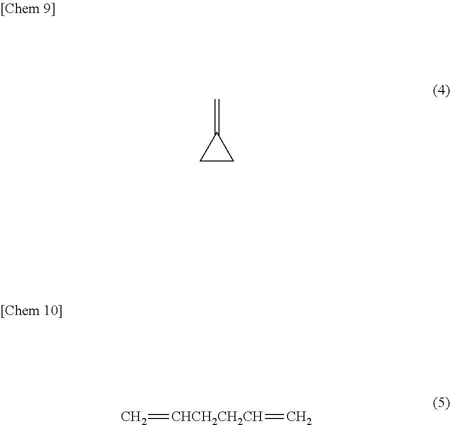

The method for manufacturing a release film according to the present invention includes: a step of applying a release agent to a base-material film; and a step of curing the applied release agent.

In the method for manufacturing a release film according to the present invention, a general coating method can be used as the step of applying a release agent to a base-material film. For example, coating methods such as gravure coating, gravure reverse coating, lip coating, die coating, microgravure coating, Meyer bar coating, and multistage reverse coating can be used.

In the method for manufacturing a release film according to the present invention, the step of curing the applied release agent is not limited, and heat treatment is preferably performed at 100 to 200° C. for 5 to 40 seconds, preferably at 120 to 160° C. for 8 to 40 seconds. When the residual solvent remains in the release layer in an amount of 1 ppm or more and the release film is insufficiently cured, the release layer may be deformed, the peel strength may increase, and adhesion to the base material may be deteriorated. If necessary, heat treatment and active energy ray irradiation such as ultraviolet irradiation may be used in combination.

Examples of the optical member to be bonded to the surface of the adhesive layer of the release film of the present invention include panel constituent members used in the manufacturing process of a polarizing plate and a display panel used for liquid crystal televisions, smartphones, and tablets.

In the present invention, the adhesive is not particularly limited, and preferably an acrylic adhesive. In addition, an ultraviolet curable adhesive and the like are exemplified. By irradiating the ultraviolet curable adhesive with ultraviolet rays, a base polymer is crosslinked by a polymerizable compound, and the storage elastic modulus of the adhesive is increased. The composition of the ultraviolet curable adhesive is not particularly limited, but generally contains a base polymer and a polymerizable compound. The polymerization curing method by ultraviolet irradiation may be any of a radical type, a cation type, and an anion type, and a light induction type alternating copolymerization type that does not require an initiator can also be used. In addition, a hybrid type in which these are combined may be used. In general, a radical type or a cation type is often used.

Examples of the polymerizable compound include various types such as polyester, acrylic, urethane, amide, silicone, and epoxy, and include ultraviolet-curable monomers, oligomers, and prepolymers. The polymerizable compound preferably has an ultraviolet polymerizable functional group, and among them, a compound containing an acrylic monomer component or an acrylic oligomer component each having two or more such functional groups is preferable. The two or more polymerizable functional groups may be the same or different. Examples of the ultraviolet curable acrylic compound include a polyfunctional acrylate, an epoxy acrylate, a urethane acrylate, a polyester acrylate, a polyether acrylate, and a spiroacetal acrylate. These polymerizable compounds may be present in the adhesive composition or may be bonded to a functional group such as a hydroxy group of the base polymer.

The ultraviolet curable adhesive preferably contains a photopolymerization initiator. The photopolymerization initiator generates radicals, acids, bases, and the like by ultraviolet irradiation, and can be appropriately selected according to the type of the polymerizable compound and the like. A photoradical generator is preferably used for photoradical polymerization, a photoacid generator is preferably used for photocationic polymerization, and a photobase generator is preferably used for photoanionic polymerization. As the photoradical generator, a compound having one or two or more of radical generation points in the molecule is used. Examples thereof include a hydroxyketone, a benzyldimethylketal, an aminoketone, an acylphosphine oxide, a benzophenone, and a trichloromethyl group-containing triazine derivative.

The base polymer of the ultraviolet curable adhesive is not particularly limited. Polymers such as an acrylic polymer, a silicone polymer, a polyester, a polyurethane, a polyamide, a polyvinyl ether, a vinyl acetate/vinyl chloride copolymer, a modified polyolefin, an epoxy, a fluorine, and a rubber such as a natural rubber and a synthetic rubber can be appropriately selected and used.

As the adhesive excellent in optical transparency and adhesiveness, an acrylic adhesive containing an acrylic polymer as a base polymer is preferably used. In the acrylic adhesive, the acrylic base polymer is contained in an amount of preferably 50 wt % or more, more preferably 70 wt % or more, and still more preferably 80 wt % or more, based on the total solid content of the adhesive composition.

As the acrylic polymer, a polymer having a monomer unit of a (meth) acrylic acid alkyl ester as a main skeleton is suitably used. In the present specification, the “(meth) acryl” means acryl and/or methacryl. As the (meth) acrylic acid alkyl ester, a (meth) acrylic acid alkyl ester having an alkyl group with 1 to 20 carbon atoms is suitably used. The (meth) acrylic acid alkyl ester is contained in an amount of preferably 40 wt % or more, more preferably 50 wt % or more, still more preferably 60 wt % or more, based on the total amount of the monomer components constituting the base polymer. The acrylic base polymer may be a copolymer of two or more (meth) acrylic acid alkyl esters. The arrangement of constituent monomer units may be random or block.

The acrylic base polymer preferably contains, as a copolymerization component, an acrylic monomer unit having a crosslinkable functional group. The base polymer with a crosslinkable functional group can be easily cured by ultraviolet irradiation. Examples of the acrylic monomer having a crosslinkable functional group include a hydroxy group-containing monomer and a carboxy group-containing monomer. Among them, a hydroxy group-containing monomer is preferably contained as the copolymerization component of the base polymer. When the base polymer has a hydroxy group-containing monomer as a monomer unit, the base polymer is improved in crosslinkability, and cloudiness of the adhesive under a high-temperature and high-humidity environment tends to be suppressed, so that a highly transparent adhesive is obtained.

The acrylic base polymer preferably contains a monomer unit having high polarity such as a nitrogen-containing monomer in addition to the (meth) acrylic acid alkyl ester and the hydroxy group-containing monomer unit. When a monomer unit having high polarity such as a nitrogen-containing monomer unit is contained in addition to the hydroxy group-containing monomer unit, the adhesive has high adhesiveness and holding force, and cloudiness under a high-temperature and high-humidity environment is suppressed.

The acrylic polymer as a base polymer is obtained by polymerizing the monomer components by various known methods such as solution polymerization, emulsion polymerization, and bulk polymerization. The solution polymerization method is suitable from the viewpoint of the balance of properties such as adhesive force and holding force of the adhesive, cost, and the like.

The base polymer of the ultraviolet curable adhesive may have a crosslinked structure introduced therein. The crosslinked structure is formed, for example, by adding a crosslinking agent and heating the mixture after the base polymer is polymerized. As the crosslinking agent, commonly used crosslinking agents can be used, including an isocyanate crosslinking agent, an epoxy crosslinking agent, an oxazoline crosslinking agent, an aziridine crosslinking agent, a carbodiimide crosslinking agent, and a metal chelate crosslinking agent. In addition, when a radically polymerizable compound having a functional group that can be bonded to the functional group of the base polymer and a radically polymerizable functional group is mixed with the base polymer, the radically polymerizable functional group can be introduced into the base polymer. The functional group that can be bonded to the functional group of the base polymer is preferably an isocyanate group. Since the isocyanate group forms a urethane bond with the hydroxy group of the base polymer, the radically polymerizable functional group can be easily introduced into the base polymer.

The adhesive composition may contain a silane coupling agent or a tackifier for the purpose of adjusting adhesive force. The adhesive composition may contain additives such as a plasticizer, a softener, a deterioration inhibitor, a filler, a colorant, an antioxidant, a surfactant, and an antistatic agent.

The adhesive may have a single layer or a multilayer structure in which two or more adhesives are laminated. When the adhesive has a multilayer structure, at least one layer is an ultraviolet curable adhesive, and all the layers may be ultraviolet curable adhesives.

The thickness of the adhesive is preferably 20 μm or more. The adhesive with a thickness of 20 μm or more can be bonded to a front transparent member such as a touch panel or a front transparent plate, such that step absorbability is imparted for the steps of the printed portion of the front transparent member. The upper limit of the thickness of the adhesive is not particularly limited, but is preferably 500 μm or less, more preferably 300 μm or less, still more preferably 100 μm or less in view of weight reduction and thickness reduction of the image display device, ease of forming the adhesive, handling, and the like. In the method for manufacturing a release film according to the present invention, at least one of the release agents has at least absorption of νC—H, νSi-H, δSi—CH₃, νSi—C, and νSi—O—Si in an IR measurement spectrum. In the IR measurement spectrum, the νC—H absorption is around 2964 cm⁻¹, the νSi-H absorption is around 2168 cm⁻¹, the δSi—CH₃ absorption is around 1412 cm⁻¹, the νSi—C absorption is around 1261 cm⁻¹ and around 801 cm⁻¹, and the νSi—O—Si absorption is around 1096 cm⁻¹ and around 1022 cm⁻¹. In the present invention, IR measurement refers to infrared spectroscopy, and is measured by the method described later.

In the method for manufacturing a release film according to the present invention, thermal decomposition GC/MS measurement is performed by the method described later.

In the method for manufacturing a release film according to the present invention, substituents Si—CH₃, Si—CH₂CH₂CH₂CH₂CH═CH₂, and Si—H preferably have molar ratios of 90 or more and 99 or less, 0.3 or more and 3.0 or less, and 0.3 or more and 3.0 or less, respectively, the molar ratios being calculated from ¹H NMR spectrum. The peak of the substituent Si—CH₃ calculated from the ¹H NMR spectrum is around −0.1 to 0.4 ppm, the peak of Si—CH₂CH₂CH₂CH₂CH═CH₂ is around 5.8 ppm, and the peak of Si—H is around 4.7 ppm. In the present invention, the ¹H NMR spectrum is measured by the method described later.

As at least one of the release agents to form the release layer, a release agent having a spectrum absorption in IR measurement, detection products in thermal decomposition GC/MS measurement, and the molar ratios of the substituents calculated from ¹H NMR spectrum in the above state and range is used to form a release layer. Thereby, a release film can be manufactured so that the elastic modulus of the release film measured from the release layer surface side using an atomic force microscope and the deformation of the release layer, each of which is an object of the present invention, are within the scope of an object of the present invention.

### EXAMPLES

Hereinafter, the present invention will be described in more detail with reference to Examples, but the present invention is not limited to the following Examples.

The measurement methods used in the present invention are as follows.

### [Measurement Methods]

### (1) Measurement of Elastic Modulus (E) of Release Film by Atomic Force Microscope

The surface of the release film on the side of the base-material film was bonded to a stainless steel sample stand using a double-sided adhesive tape. Subsequently, using a probe microscope (product name “SPM-9700” manufactured by Shimadzu Corporation) equipped with a silicone probe (product name “LRCH” manufactured by Team nanotec, curvature radius: 250 nm, spring constant: 0.2 N/m), the surface of the release film on the release layer side was tapped at 600 nm/s to obtain a force curve. From the shape of the obtained force curve, the elastic modulus (E) (MPa) of the release film was calculated by the JKR2 point method.

### (2) Thickness of Release Layer

After the release film was embedded in a resin, a small piece was taken out therefrom in the cross-sectional direction by the FIB method for transmission electron microscope, and the cross section of the small piece was observed by using a transmission electron microscope (TEM, manufacturer: JEOL Ltd., type name: JEM-F200, acceleration voltage: 200 V, magnification: 200,000). In the obtained TEM observation image, the total thickness of the release layer was measured at 3 points, and the average of the obtained values was defined as the thickness.

### (3) Height Difference of Deformation of Release Layer

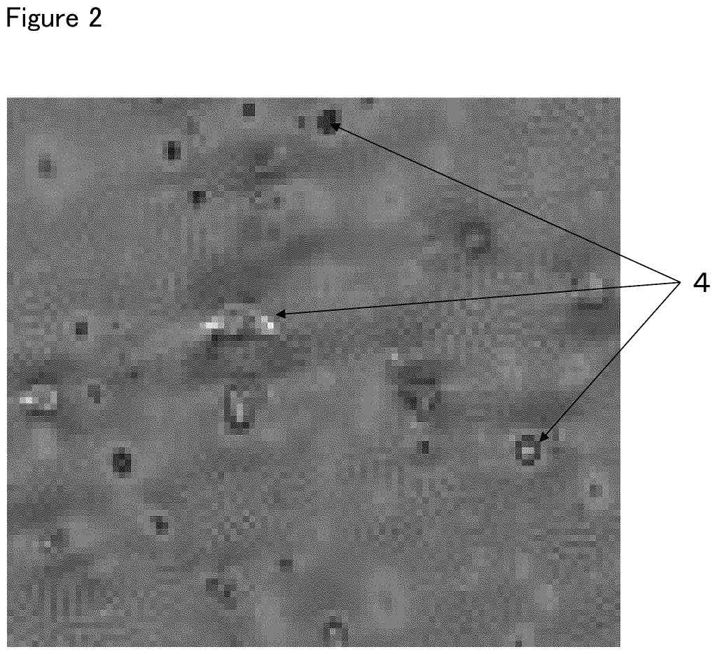

Ten release films were stacked such that the base material side and the release layer side were in contact with each other, and then the stack was cut into 5 cm×5 cm. Subsequently, the stack was allowed to stand at 23° C. for 24 hours while being pressed at 10 MPa in the stacking direction. Thereafter, the surface of the release layer of the fifth release film from the upper side of the stack was observed with a laser microscope (manufacturer: KEYENCE CORPORATION, type name: Laser Microscope VK-X200) under the conditions of an objective lens magnification of 150 and an eyepiece lens magnification of 20 (total magnification of 3000). Since particles were added to the base-material film for the purpose of preventing blocking, easily slipping, or the like, a horizontal distance of 10 μm was measured at 5 places where no particle of 0.5 μm or more (FIG. 2, reference sign 4) was included, so that the maximum height difference was determined as the height difference of the deformation of the release layer.

### (4) Peel Strength Between Release Film and Adhesive Tape

On the surface of the release film on the release layer side, a polyester adhesive tape (Nitto Denko Corporation, No. 31B tape, 50 mm wide) as an adhesive tape was bonded by pressing with a 5 kg roller and left standing at 23° C. for 24 hours, and then the tape was peeled off with a tensile tester at a peeling rate of 300 mm/min and a peeling angle of 180°. At this time, the peel strength was measured.

### (5) Spectrum Absorption in IR Measurement of Release Agent

The release agent was measured with an IR measurement apparatus (iS5, manufactured by Thermo Fisher SCIENTIFIC, sample scan count: 64 times, background scan count: 64 times, resolution: 8.0), and the obtained spectrum absorption was as follows. When all of the following absorptions were confirmed, it was rated as ∘; and when even any one of them was not confirmed, it was rated as x.
νC—H absorption: Absorption around 2964 cm⁻¹
νSi-H absorption: Absorption around 2168 cm⁻¹
δSi—CH₃ absorption: Absorption around 1412 cm⁻¹
νSi—C absorption: Absorption around 1261 cm⁻¹ and around 801 cm⁻¹
νSi—O—Si absorption: Absorption around 1096 cm⁻¹ and around 1022 cm⁻¹

### (6) Detection Product of Release Agent in Thermal Decomposition GC/MS Measurement

The release agent was measured and analyzed by using: a gas chromatograph 7890A manufactured by Agliment Technologies (conditions: Column: “Ultra Alloy (registered trademark)”-5 (MS/HT), Column temperature: 40° C. (3 minutes)—320° C. (18 minutes) (Rate 20° C./min), Injestion temperature: 300° C.); a mass spectrometer JMS-Q1050GC manufactured by JEOL Ltd. (conditions: Ionization Mode: EI+, Scan Range: m/z 10.0-800.0, Scan Rate: 05 seconds/scan); and a thermal decomposition comprehensive analysis system (Pyrolyzer PY-2020iD manufactured by Frontier Laboratories Ltd., temperature 600° C.). When all of the following general formulae (1), (2), (3), (4), and (5) were confirmed, it was rated as ∘; and when even any one of them was not confirmed, it was rated as x.

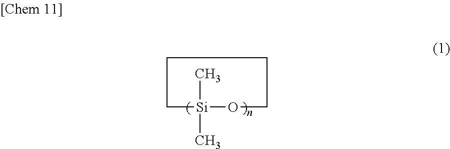

(n represents an integer of 1 to 20)

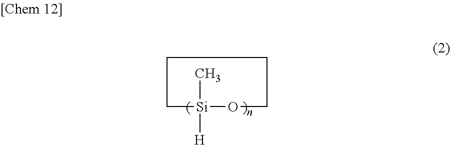

(n represents an integer of 1 to 20)

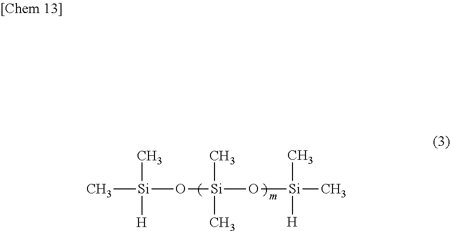

(m represents an integer of 1 to 10)

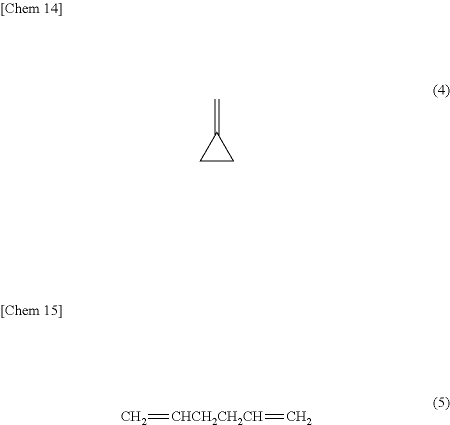

(7) Substituents calculated from ¹H NMR spectrum

The release agent was subjected to ¹H NMR spectrum measurement by using an NMR measurement apparatus (ECA-400 manufactured by jeol RESONANCE), and the molar ratios of substituents Si—CH₃, Si—CH₂CH₂CH₂CH₂CH═CH₂, and Si—H were calculated.

### Example 1

A primer coating liquid was prepared by mixing 3 parts by weight of BY24-846B (manufactured by Dow Corning Toray Co., Ltd., content: 98 wt %), which is 3-glycidoxypropyltrimethoxysilane, 1 part by weight of BY24-846C (manufactured by Dow Corning Toray Co., Ltd., content: 99 wt %), which is 3-methacryloxypropyltrimethoxysilane, and 2 parts by weight of BY24-846E (manufactured by Dow Corning Toray Co., Ltd., content: 38 wt %), which is bis(ethylacetoacetate) (2,4-pentanedionate)aluminum, with 50 parts by weight of toluene and 50 parts by weight of isopropyl alcohol (IPA).

Uniformly mixed were 100 parts by weight of a dimethylsiloxane-methylhexenylsiloxane copolymer having both molecular chain terminals capped with dimethylhexenylsiloxy groups (viscosity: 200 mPa·s), 13.8 parts of dimethylpolysiloxane having both terminals capped with dimethylhydrogensiloxy groups (silicon atom-bonded hydrogen atom content: 0.12 wt %, viscosity: 15 mPa·s), 1.5 parts of methylhydrogenpolysiloxane having both terminals capped with trimethylsiloxy groups (silicon atom-bonded hydrogen atom content: 1.6 wt %, viscosity: 20 mPa·s), 0.3 parts by weight of 1-ethynyl-1-cyclohexanol, and 10 parts of dimethylpolysiloxane having both terminals capped with trimethylsiloxy groups (viscosity: 300000 mPa·s). Subsequently, the mixture was blended with a complex salt of chloroplatinic acid and 1,3-divinyltetramethyldisiloxane in an amount such that the amount of platinum metal was 200 ppm (weight) to prepare a silicone composition for forming a releasable cured film having a viscosity of about 400 mPa·s. A release layer coating liquid 1 was prepared by mixing 4 parts by weight of the obtained silicone composition for forming a releasable cured film and 0.08 parts by weight of a platinum catalyst SRX212 (manufactured by Dow Toray Co., Ltd.) as a curing agent with 50 parts by weight of toluene, and 46 parts by weight of n-heptane.

The primer coating liquid was applied to a polyethylene terephthalate film having a thickness of 38 μm (“Lumirror (registered trademark)” XF60R manufactured by Toray Industries, Inc.) with a Meier bar No. 3 so that the coating thickness after drying was 0.05 μm, and dried and cured at 100° C. for 5 seconds. Thereafter, the release layer coating liquid 1 was continuously applied with a Meier bar No. 5 so that the release layer thickness was 0.15 μm, and dried and cured at 160° C. for 20 seconds to obtain a release film. The elastic modulus, the thickness of the release layer, the peel strength, and the height difference of the deformation of the release layer were measured, and the results are shown in Table 1. Obtained was a release film having a small peel strength and no deformation of the release layer.

### Example 2

A release film was obtained in the same manner as in Example 1 except that a release layer coating liquid 2 was used instead of the release layer coating liquid 1 in Example 1. Uniformly mixed were 100 parts by weight of a dimethylsiloxane-methylhexenylsiloxane copolymer having both molecular chain terminals capped with dimethylhexenylsiloxy groups (viscosity: 200 mPa·s), 13.8 parts of dimethylpolysiloxane having both terminals capped with dimethylhydrogensiloxy groups (silicon atom-bonded hydrogen atom content: 0.12 wt %, viscosity: 15 mPa·s), 1.5 parts of methylhydrogenpolysiloxane having both terminals capped with trimethylsiloxy groups (silicon atom-bonded hydrogen atom content: 1.6 wt %, viscosity: 20 mPa·s), 0.3 parts by weight of 1-ethynyl-1-cyclohexanol, and 10 parts of dimethylpolysiloxane having both terminals capped with trimethylsiloxy groups (viscosity: 300000 mPa·s). Subsequently, the mixture was blended with a complex salt of chloroplatinic acid and 1,3-divinyltetramethyldisiloxane in an amount such that the amount of platinum metal was 200 ppm (weight) to prepare a silicone composition for forming a releasable cured film having a viscosity of about 400 mPa·s. Then 3 parts by weight of the obtained silicone composition for forming a releasable cured film and 59.2 g of cyclotetrasiloxane containing a silicon atom-bonded hydrogen atom were added with 0.7 g of a platinum-supported carbon powder (platinum content: 0.5 wt %), and heated to 150° C., and while the mixture was being stirred, 50 g of α-methylstyrene was added dropwise thereto. Thereafter, heating and stirring were further continued at 150° C. for 3 hours. Next, the mixture was cooled and filtered, and heated to 150° C. under reduced pressure to remove volatiles, and thereby a reaction product was obtained. Then 1 part by weight of the reaction product and 0.08 parts by weight of a platinum catalyst SRX212 (manufactured by Dow Toray Co., Ltd.) as a curing agent were mixed with 50 parts by weight of toluene and 46 parts by weight of n-heptane to obtain the release layer coating liquid 2. The elastic modulus, the thickness of the release layer, the peel strength, and the height difference of the deformation of the release layer were measured, and the results are shown in Table 1. Obtained was a release film having a small peel strength and no deformation of the release layer.

### Examples 3 and 4

A release film was obtained in the same manner as in Example 1 except that the total thickness of the release layer was changed. The elastic modulus, the thickness of the release layer, the peel strength, and the height difference of the deformation of the release layer were measured, and the results are shown in Table 1. Obtained was a release film having a small peel strength and no deformation of the release layer.

### Comparative Example 1

A release film was obtained in the same manner as in Example 1 except that a release layer coating liquid 3 was used instead of the release layer coating liquid 1 in Example 1. Uniformly mixed were 20 parts by weight of dimethylpolysiloxane having both molecular chain terminals capped with dimethylvinylsiloxy groups (viscosity: 2000 mPa·s, vinyl group content: 0.2 wt %), 80 parts by weight of dimethylpolysiloxane having both molecular chain terminals capped with dimethylvinylsiloxy groups (viscosity: 370 mPa·s, vinyl group content: 0.47 wt %), 14.5 parts by weight of dimethylpolysiloxane capped with dimethylhydrogensiloxy groups (silicon atom-bonded hydrogen atom content: 0.12 wt %, viscosity: 15 mPa·s), 1.5 parts by weight of a dimethylsiloxane/methylhydrogensiloxane copolymer having both molecular chain terminals capped with trimethylsiloxy groups including 30 mol % of dimethylsiloxane units and 70 mol % of methylhydrogensiloxane units (silicon atom-bonded hydrogen atom content: 1.0 wt %, viscosity: 70 mPa·s), and 0.1 parts by weight of 3-methyl-1-butyne-3-ol. Subsequently, the mixture was blended with a complex salt of chloroplatinic acid and 1,3-divinyltetramethyldisiloxane in an amount such that the amount of platinum metal was 200 ppm to prepare a silicone composition for forming a releasable cured film having a viscosity of about 300 mPa·s. Then 8 parts by weight of the obtained silicone composition for forming a releasable cured film and 0.08 parts by weight of a platinum catalyst PL-50T (manufactured by Shin-Etsu Chemical Co., Ltd.) as a curing agent were mixed with 28 parts by weight of toluene and 64 parts by weight of n-heptane to obtain the release layer coating liquid 3. The elastic modulus, the thickness of the release layer, the peel strength, and the height difference of the deformation of the release layer were measured, and the results are shown in Table 1. As a poor result, the elastic modulus was low and the peel strength was light, but the release layer was deformed.

### Comparative Example 2

A release film was obtained in the same manner as in Example 1 except that a release layer coating liquid 3 was used instead of the release layer coating liquid 1 in Example 1. One part by mass of a melamine compound (RP-50 manufactured by MITSUWA CHEMICAL LAB. CO., LTD, solid content: 50 mass %) as a thermosetting resin and 9 parts by mass of a mixture of toluene, anone, and methanol (4.5/3.6/0.9) were mixed to obtain a solution, and the solution was mixed with 0.1 parts by mass of DEP clear (manufactured by WASHIN CHEMICAL INDUSTRY CO., LTD.) as a curing agent to prepare the release layer coating liquid 3. The elastic modulus, the thickness of the release layer, the peel strength, and the height difference of the deformation of the release layer were measured, and the results are shown in Table 1. As a poor result, the elastic modulus was high and the peel strength was increased.

### Comparative Example 3

A release film was obtained in the same manner as in Example 1 except that a release layer coating liquid 4 was used instead of the release layer coating liquid 1 in Example 1, and the release layer coating liquid 4 was applied with a Meyer bar No. 10 so that the release layer thickness was 0.4 μm, and dried and cured at 40° C. for 20 seconds. Uniformly mixed were 100 parts by weight of a dimethylsiloxane-methylhexenylsiloxane copolymer having both molecular chain terminals capped with dimethylhexenylsiloxy groups (viscosity: 200 mPa·s), 6.9 parts of dimethylpolysiloxane having both terminals capped with dimethylhydrogensiloxy groups (silicon atom-bonded hydrogen atom content: 0.12 wt %, viscosity: 15 mPa·s), 0.75 parts of methylhydrogenpolysiloxane having both terminals capped with trimethylsiloxy groups (silicon atom-bonded hydrogen atom content: 1.6 wt %, viscosity: 20 mPa·s), 0.3 parts by weight of 1-ethynyl-1-cyclohexanol, and 5 parts of dimethylpolysiloxane having both terminals capped with trimethylsiloxy groups (viscosity: 300000 mPa·s). Subsequently, the mixture was blended with a complex salt of chloroplatinic acid and 1,3-divinyltetramethyldisiloxane in an amount such that the amount of platinum metal was 200 ppm (weight) to prepare a silicone composition for forming a releasable cured film having a viscosity of about 400 mPa·s. Then 4 parts by weight of the obtained silicone composition for forming a releasable cured film and 0.04 parts by weight of a platinum catalyst SRX-212 (manufactured by Dow Toray Co., Ltd.) as a curing agent were mixed with 50 parts by weight of toluene and 46 parts by weight of n-heptane to obtain the release layer coating liquid 4. The elastic modulus, the thickness of the release layer, the peel strength, and the height difference of the deformation of the release layer were measured, and the results are shown in Table 1. As a result, the elastic modulus was low and the peel strength was light, but the release layer was blocked and workability was poor.

TABLE 1-1

| | | | Release agent | |
|---|---|---|---|---|
| | Elastic | Thickness | | Thermal |
| | modulus | of release | Spectrum | decomposition |
| | (E) | layer | absorption in | GC/MS |
| | (MPa) | (μm) | IR measurement | detection |
| Example 1 | 1.8 | 0.15 | ◯ | ◯ |
| Example 2 | 1.6 | 0.15 | ◯ | ◯ |
| Example 3 | 1.5 | 0.27 | ◯ | ◯ |
| Example 4 | 4.2 | 0.05 | ◯ | ◯ |
| Comparative | 1.2 | 0.31 | X | X |
| Example 1 | | | | |
| Comparative | 5.2 | 0.02 | X | X |
| Example 2 | | | | |
| Comparative | 0.8 | 0.40 | X | X |
| Exemple 3 | | | | |

TABLE 1-2

| | | | | | Characteristics | |
|---|---|---|---|---|---|---|
| | | | | | | Height difference |
| | Release agent | | | | 31B Peel | of deformation of |
| | ²H NMR spectrum substituent molar ratio | | | | strength | release layer |
| | Si—CH₃ | Si—CH₂CH₂CH₃CH₃CH═CH₂ | Si—H | Total | (mN/50 mm) | (μm) |
| Example 1 | 97.3 | 1.3 | 1.4 | 100.0 | 64 | 0.05 |
| Example 2 | 98.7 | 0.8 | 0.5 | 100.0 | 57 | 0.03 |
| Example 3 | 97.3 | 1.3 | 1.4 | 100.0 | 40 | 0.05 |
| Example 4 | 97.3 | 1.3 | 1.4 | 100.0 | 85 | 0.04 |
| Comparative | 97.2 | 0.0 | 2.8 | 100.0 | 40 | 0.11 |
| Example 1 | | | | | | |
| Comparative | 0.0 | 0.0 | 0.0 | 0.0 | 120 | 0.06 |
| Example 2 | | | | | | |
| Comparative | 92.5 | 3.5 | 4.0 | 100.0 | 4 | 0.05 |
| Example 3 | | | | | | |

As shown in Table 1, the release films according to Examples had a much smaller peel strength than the release films according to Comparative Examples. Furthermore, in the release films according to Examples, the height difference in the deformation of the release layer was small.

### INDUSTRIAL APPLICABILITY

The release film of the present invention has a small peel strength and small height difference in the deformation of the release layer, and can be stably used in a manufacturing process, and therefore, can be suitably used for manufacturing various thinned electronic members, which constitute the thinning liquid crystal televisions, smartphones, and tablets.

### DESCRIPTION OF REFERENCE SIGNS

1: Base-material film
2: Release layer
3: Release film
4: Foreign matter

1. A release film comprising: a base-material film; and a release layer on at least one surface of the base-material film, wherein the release film has an elastic modulus (E) of 1.5 MPa or more and less than 5.0 MPa, the elastic modulus (E) being measured from a release layer side using an atomic force microscope; the release layer has a thickness of 0.03 μm or more and less than 0.3 μm; and the release layer has a maximum height difference of 0.1 μm or less after pressurized at 10 MPa.

2. The release film according to claim 1, wherein, when the release layer is bonded with an adhesive tape and left standing at 23° C. for 24 hours, and then the adhesive tape is peeled off at a peeling rate of 300 mm/min and a peeling angle of 180°, the release film and the adhesive tape have a peel strength of 5 mN/50 mm or more and 100 mN/50 mm or less.

3. A film laminate comprising: the release film according to claim 1; and an optical member bonded to the release film through an adhesive layer.

4. A method for manufacturing a release film having: a base-material film; and a release layer on at least one surface of the base-material film, the method comprising:
a step of applying a release agent to a base-material film; and a step of curing the applied release agent,
wherein at least one of the release agents has at least one absorption selected from the group consisting of νC—H, νSi—H, δSi—CH₃, νSi—C, and νSi—O—Si in an IR measurement spectrum;
thermal decomposition products of following formulae (1) to (5) are detected by thermal decomposition gas chromatograph mass spectrometry; and
substituents Si—CH₃, Si—CH₂CH₂CH₂CH₂CH═CH₂, and Si—H have molar ratios of 90.0 or more and 99.0 or less, 0.3 or more and 3.0 or less, and 0.3 or more and 3.0 or less, respectively, the molar ratios being calculated from 1H NMR spectrum. 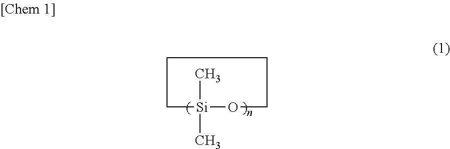
(n represents an integer of 1 to 20) 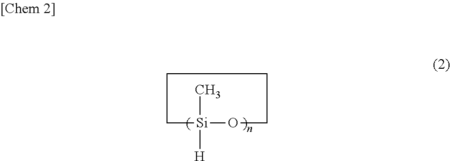
(n represents an integer of 1 to 20) 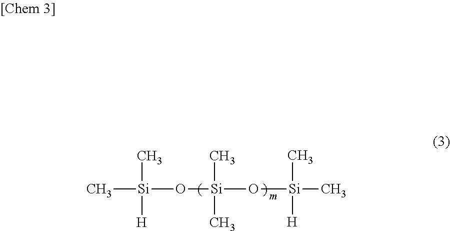
(m represents an integer of 1 to 10) [chemical structure]
